(19) United States
(12) Patent Application Publication
(10) Pub. No.: US 2025/0032231 A1
(43) Pub. Date: Jan. 30, 2025

(54) TOOTH HYGIENE SYSTEM, A DUAL-TANK FLOSSER SYSTEM, A HOSE AND TANK SYSTEM, PROCESSES, AND METHODS OF USE

(71) Applicant: Vaipito Foalima, Mesa, AZ (US)

(72) Inventor: Vaipito Foalima, Mesa, AZ (US)

(21) Appl. No.: 18/764,222

(22) Filed: Jul. 4, 2024

Related U.S. Application Data
(60) Provisional application No. 63/528,840, filed on Jul. 25, 2023.

(51) Int. Cl. A61C 17/02; A61C 17/028

(52) U.S. Cl. CPC A61C 17/0202; A61C 17/0205; A61C 17/028

(57) ABSTRACT

A tooth hygiene system, a system dental hygiene, a dual tank flosser system, a hose and tank cleaning system, processes, and methods of use are presented. More specifically and without limitation, the present disclosure relates to a liquid flosser or water flosser. More specifically, and without limitation, the present disclosure relates to a tooth hygiene system which improves upon the state of the art and solves the gaps of not cleaning thoroughly and adding benefits to tooth cleaning beyond brushing.

### CROSS-REFERENCE TO RELATED APPLICATIONS

The present application claims priority to the U.S. Provisional Patent Application No. 63/528,840 which was filed on Jul. 25, 2023, which is hereby incorporated by reference herein in its entirety, including any figures, tables, or drawings.

### FIELD OF THE INVENTION

This disclosure relates to a tooth hygiene system, a system dental hygiene, a dual tank flosser system, a hose and tank cleaning system, processes, and methods of use. More specifically, and without limitation, the present disclosure relates to a system for dental hygiene, the system including two tanks for housing content which can be switched to utilizing a single or multiple devices.

### BACKGROUND OF THE INVENTION

In recent times, few improvements have been made to dental hygiene. Most users and households engage in regular brushing of teeth and some flossing. Few changes to this standard have been implemented. Brushing teeth is well known in the art. Tooth brushing is the act of scrubbing teeth with a toothbrush. Small advances continue to be made in the shape of toothbrushing but the general idea hasn't changed in a very long time. Generally a toothbrush is combined with toothpaste and water to engage in cleaning one's teeth.

Similarly, flossing is a common practice. Generally, flossing is the act of using a thin piece of material to remove plaque and other debris from between teeth and/or other locations within the mouth in which a toothbrush has difficulty reaching. Flossing, like brushing, is a regular part of oral cleaning and has remained limited in improvements in many years.

It is well known in the art that regular flossing and brushing can improve dental health and prevent gum disease. However, evidence also shows that flossing is a very limited benefit. Some studies have shown that common flossing is limited in removing plaque or providing benefits beyond brushing. Furthermore, flossing is inaccurate and may not be effective in reaching all of the difficult to reach places.

Thus, there is a long-felt need in the art for a tooth hygiene system, a system dental hygiene, a dual tank flosser system, a hose and tank cleaning system, processes, and methods of use which improves upon the state of the art and solves the gaps of not cleaning thoroughly and adding benefits to tooth cleaning beyond brushing.

The disclosure herein provides these advantages and others as will become clear from the specification and claims provided.

### SUMMARY OF THE INVENTION

A tooth hygiene system, a system dental hygiene, a dual tank flosser system, a hose and tank cleaning system, processes, and methods of use are presented. More specifically and without limitation, the present disclosure relates to a liquid flosser or water flosser. More specifically, and without limitation, the present disclosure relates to a tooth hygiene system which improves upon the state of the art and solves the gaps of not cleaning thoroughly and adding benefits to tooth cleaning beyond brushing.

Thus, it is a primary object of the disclosure to provide a tooth hygiene system, a system dental hygiene, a dual tank flosser system, a hose and tank cleaning system, processes, and methods of use that improves upon the state of the art.

Another object of the disclosure is to provide a tooth hygiene system, a system dental hygiene, a dual tank flosser system, a hose and tank cleaning system, processes, and methods of use that provides a dual or two tank system.

Yet another object of the disclosure is to provide a tooth hygiene system, a system dental hygiene, a dual tank flosser system, a hose and tank cleaning system, processes, and methods of use that provides two hoses.

Another object of the disclosure is to provide a tooth hygiene system, a system dental hygiene, a dual tank flosser system, a hose and tank cleaning system, processes, and methods of use that provides a system for switching from water to mouthwash in a liquid flossing system.

Yet another object of the disclosure is to provide a tooth hygiene system, a system dental hygiene, a dual tank flosser system, a hose and tank cleaning system, processes, and methods of use that provides pressure control.

Another object of the disclosure is to provide a tooth hygiene system, a system dental hygiene, a dual tank flosser system, a hose and tank cleaning system, processes, and methods of use that provides pressure control for each of the tanks.

Yet another object of the disclosure is to provide a tooth hygiene system, a system dental hygiene, a dual tank flosser system, a hose and tank cleaning system, processes, and methods of use that provides a control switch for the water tank.

Another object of the disclosure is to provide a tooth hygiene system, a system dental hygiene, a dual tank flosser system, a hose and tank cleaning system, processes, and methods of use that provides a control switch for the mouthwash.

Yet another object of the disclosure is to provide a tooth hygiene system, a system dental hygiene, a dual tank flosser system, a hose and tank cleaning system, processes, and methods of use that provides controls for a plurality of tanks.

Another object of the disclosure is to provide a tooth hygiene system, a system dental hygiene, a dual tank flosser system, a hose and tank cleaning system, processes, and methods of use that provides a portable water flosser.

Yet another object of the disclosure is to provide a tooth hygiene system, a system dental hygiene, a dual tank flosser system, a hose and tank cleaning system, processes, and methods of use that provides a system compact enough to sit on a counter.

Another object of the disclosure is to provide a tooth hygiene system, a system dental hygiene, a dual tank flosser system, a hose and tank cleaning system, processes, and methods of use that provides a counter top flossing system with a plurality of tanks.

Yet another object of the disclosure is to provide a tooth hygiene system, a system dental hygiene, a dual tank flosser system, a hose and tank cleaning system, processes, and methods of use that provides a user can switch from using a liquid in a first tank to a liquid in a second tank or subsequent tank such that the liquid type being dispensed from the main unit can be changed without switching hoses or emptying a tank.

Another object of the disclosure is to provide a tooth hygiene system, a system dental hygiene, a dual tank flosser system, a hose and tank cleaning system, processes, and methods of use that are easy to control.

Yet another object of the disclosure is to provide a tooth hygiene system, a system dental hygiene, a dual tank flosser system, a hose and tank cleaning system, processes, and methods of use that are effective in reducing gum disease.

Another object of the disclosure is to provide a tooth hygiene system, a system dental hygiene, a dual tank flosser system, a hose and tank cleaning system, processes, and methods of use that are effective in cleaning more parts of the mouth relative to traditional flossing.

Yet another object of the disclosure is to provide a tooth hygiene system, a system dental hygiene, a dual tank flosser system, a hose and tank cleaning system, processes, and methods of use that are easy to switch from one tank to another.

Another object of the disclosure is to provide a tooth hygiene system, a system dental hygiene, a dual tank flosser system, a hose and tank cleaning system, processes, and methods of use that are easy to use.

Yet another object of the disclosure is to provide a tooth hygiene system, a system dental hygiene, a dual tank flosser system, a hose and tank cleaning system, processes, and methods of use that are safe to use.

Yet another object of the disclosure is to provide a tooth hygiene system, a system dental hygiene, a dual tank flosser system, a hose and tank cleaning system, processes, and methods of use that provides alerts.

Another object of the disclosure is to provide a tooth hygiene system, a system dental hygiene, a dual tank flosser system, a hose and tank cleaning system, processes, and methods of use that tracks historical data.

Another object of the disclosure is to provide a tooth hygiene system, a system dental hygiene, a dual tank flosser system, a hose and tank cleaning system, processes, and methods of use that are accurate.

Yet another object of the disclosure is to provide a tooth hygiene system, a system dental hygiene, a dual tank flosser system, a hose and tank cleaning system, processes, and methods of use that are quick and efficient.

Yet another object of the disclosure is to provide a tooth hygiene system, a system dental hygiene, a dual tank flosser system, a hose and tank cleaning system, processes, and methods of use that are robust.

Another object of the disclosure is to provide a tooth hygiene system, a system dental hygiene, a dual tank flosser system, a hose and tank cleaning system, processes, and methods of use that saves time for a user.

Yet another object of the disclosure is to provide a tooth hygiene system, a system dental hygiene, a dual tank flosser system, a hose and tank cleaning system, processes, and methods of use that saves energy.

Another object of the disclosure is to provide a tooth hygiene system, a system dental hygiene, a dual tank flosser system, a hose and tank cleaning system, processes, and methods of use that are high quality.

Yet another object of the disclosure is to provide a tooth hygiene system, a system dental hygiene, a dual tank flosser system, a hose and tank cleaning system, processes, and methods of use that provide warming features for warming the liquids in the plurality of tanks.

These and other objects, features, or advantages of the present disclosure will become apparent from the specification and claims.

### BRIEF DESCRIPTION OF DRAWINGS

The drawings accompanying and forming part of this specification are included to depict certain aspects of the disclosure.

FIG. 1 is a top, perspective view of the dental hygiene system; the view showing a base having a plurality of feet and a plurality of controls; the view showing a plurality of tanks; the view showing the plurality of tanks engaged with the base; the view showing a storage compartment; the view showing the storage compartment connected to the top of the plurality of tanks; the view showing a lid; the view showing the lid in the closed position on top of the storage compartment.

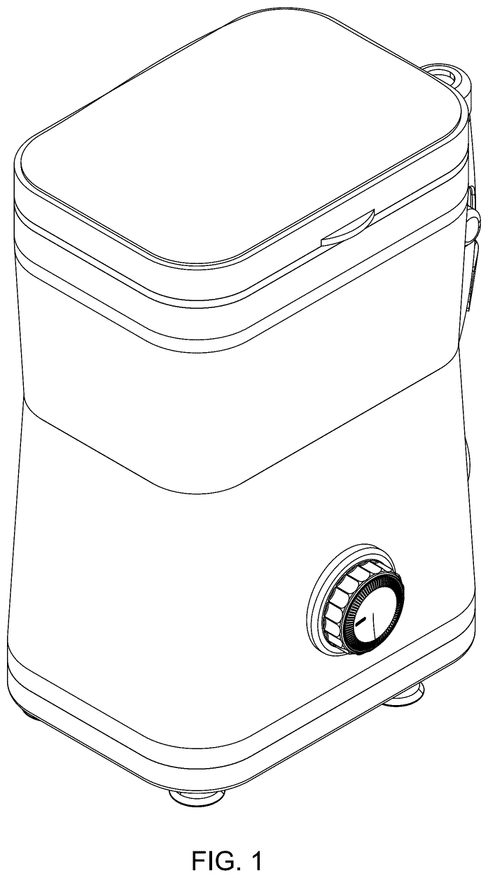

FIG. 2 is a top, perspective view of the dental hygiene system; the view showing a base having a plurality of feet and a plurality of controls; the view showing a plurality of tanks; the view showing the plurality of tanks engaged with the base; the view showing a storage compartment; the view showing the storage compartment connected to the top of the plurality of tanks; the view showing a lid; the view showing the lid in the closed position on top of the storage compartment; the view showing a flosser; the view showing the flosser having an attachment tube; the view showing the flosser mounted or stored in the flosser holder on the side of the base.

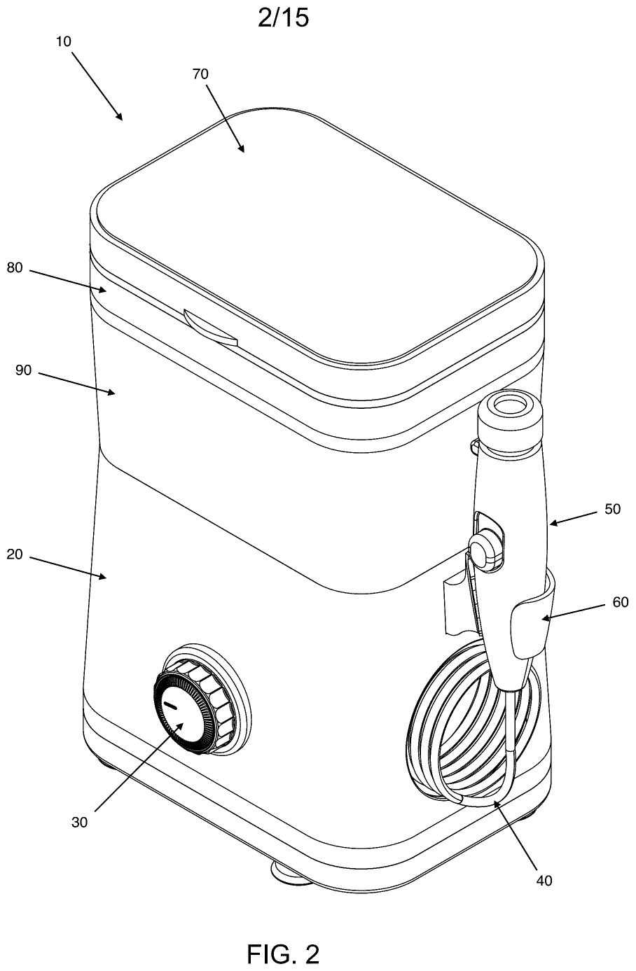

FIG. 3 is a top, rear perspective view of the dental hygiene system; the view showing a base having a plurality of feet and an on/off switch; the view showing a plurality of tanks; the view showing the plurality of tanks engaged with the base; the view showing a storage compartment; the view showing the storage compartment connected to the top of the plurality of tanks; the view showing a lid; the view showing the lid in the closed position on top of the storage compartment; the view showing a flosser; the view showing the flosser having an attachment tube; the view showing the flosser mounted or stored in the flosser holder on the side of the base.

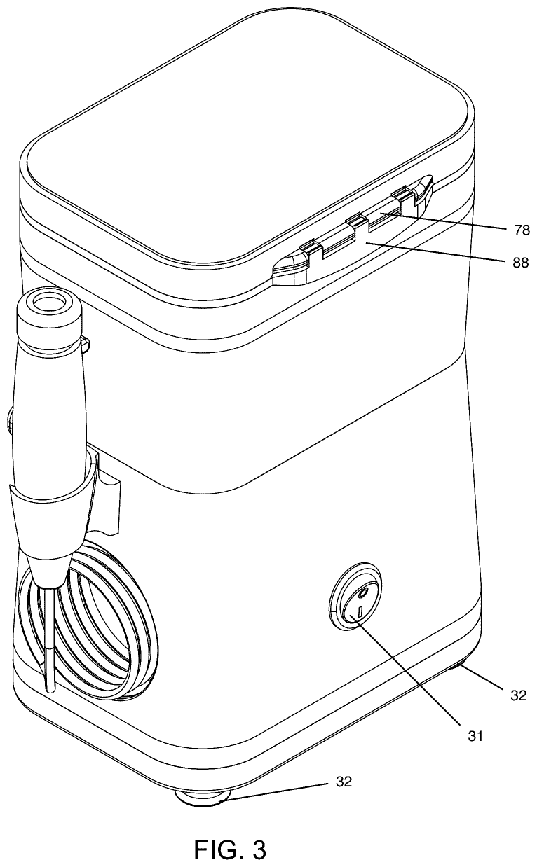

FIG. 4 is a top, rear perspective view of the dental hygiene system; the view showing a base having a plurality of feet and an on/off switch; the view showing a plurality of tanks; the view showing the plurality of tanks engaged with the base; the view showing a storage compartment; the view showing the storage compartment connected to the top of the plurality of tanks; the view showing a lid; the view showing the lid in the closed position on top of the storage compartment.

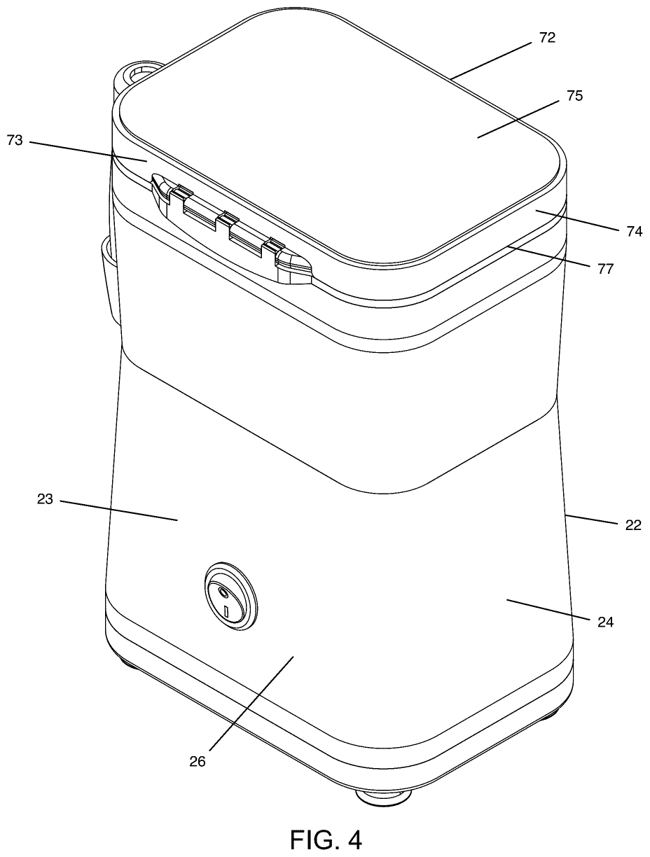

FIG. 5 is a bottom, rear perspective view of the dental hygiene system; the view showing a base having a plurality of feet and an on/off switch; the view showing a plurality of tanks; the view showing the plurality of tanks engaged with the base; the view showing a storage compartment; the view showing the storage compartment connected to the top of the plurality of tanks; the view showing a lid; the view showing the lid in the closed position on top of the storage compartment; the view showing a power source; the view showing storage area for a power cord and/or wall plug cord; the view showing the attachment location for a power cord.

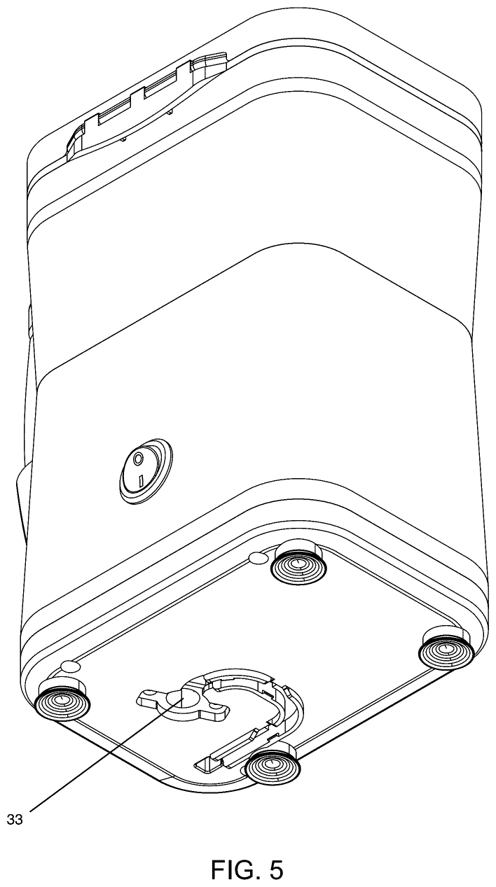

FIG. 6 is a bottom, front perspective view of the dental hygiene system; the view showing a base having a plurality of feet and plurality of controls; the view showing a plurality of tanks; the view showing the plurality of tanks engaged with the base; the view showing a storage compartment; the view showing the storage compartment connected to the top of the plurality of tanks; the view showing a lid; the view showing the lid in the closed position on top of the storage compartment; the view showing a power source; the view showing storage area for a power cord and/or wall plug cord; the view showing the attachment location for a power cord.

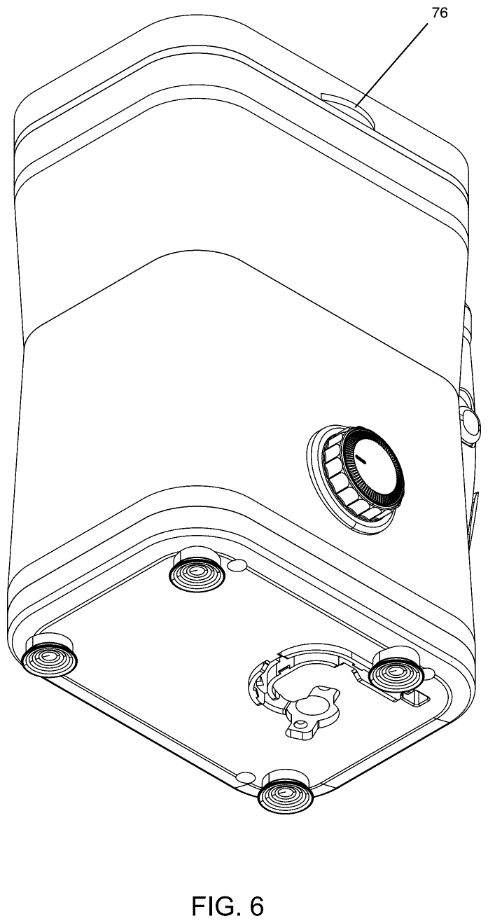

FIG. 7 is a front view of the dental hygiene system; the view showing a base having a plurality of feet and a plurality of controls; the view showing a plurality of tanks; the view showing the plurality of tanks engaged with the base; the view showing a storage compartment; the view showing the storage compartment connected to the top of the plurality of tanks; the view showing a lid; the view showing the lid in the closed position on top of the storage compartment; the view showing a flosser; the view showing the flosser having an attachment tube; the view showing the flosser mounted or stored in the flosser holder on the side of the base.

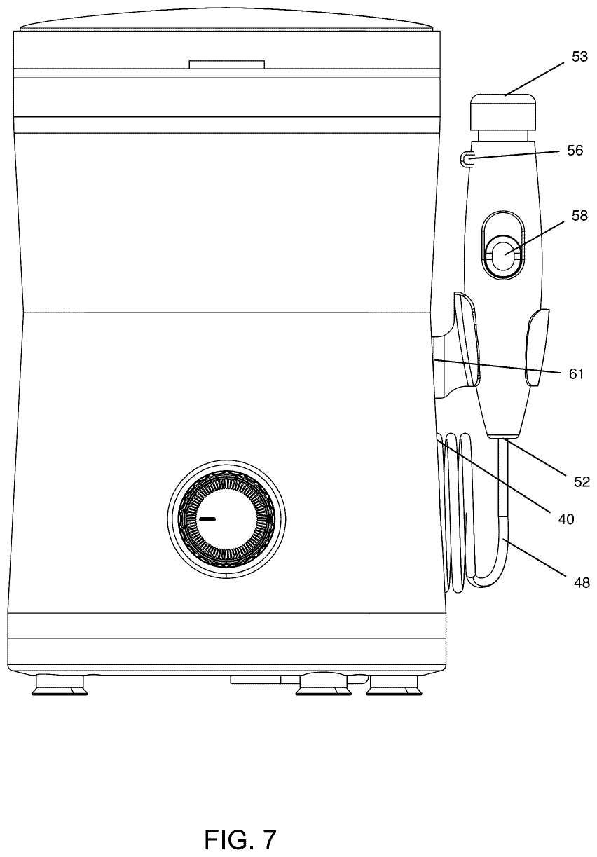

FIG. 8 is a rear view of the dental hygiene system; the view showing a base having a plurality of feet and an on/off switch; the view showing a plurality of tanks; the view showing the plurality of tanks engaged with the base; the view showing a storage compartment; the view showing the storage compartment connected to the top of the plurality of tanks; the view showing a lid; the view showing the lid in the closed position on top of the storage compartment; the view showing a flosser; the view showing the flosser having an attachment tube; the view showing the flosser mounted or stored in the flosser holder on the side of the base.

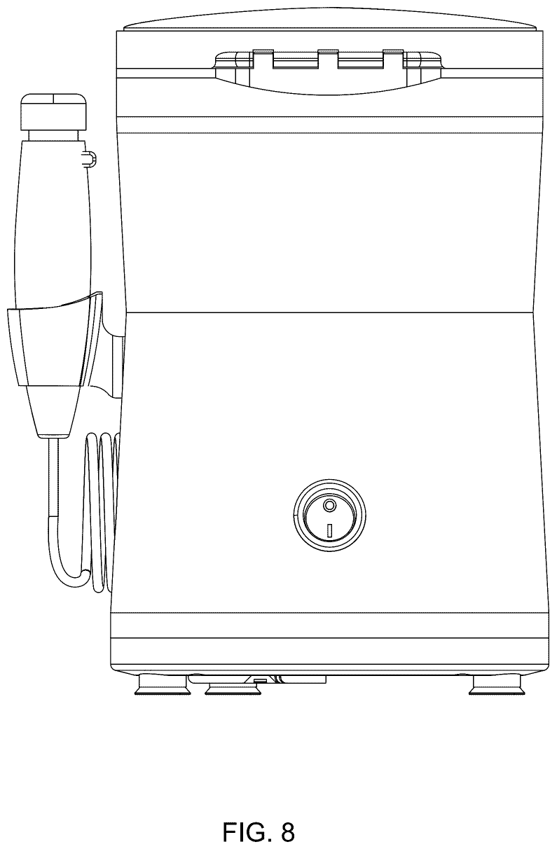

FIG. 9 is a top view of the dental hygiene system; the view showing the lid; the view showing the lip of the lid; the view showing a plurality of controls on the front side below the lip of the lid; the view showing the flosser having an attachment tube; the view showing the flosser mounted or stored in the flosser holder on the side of the base.

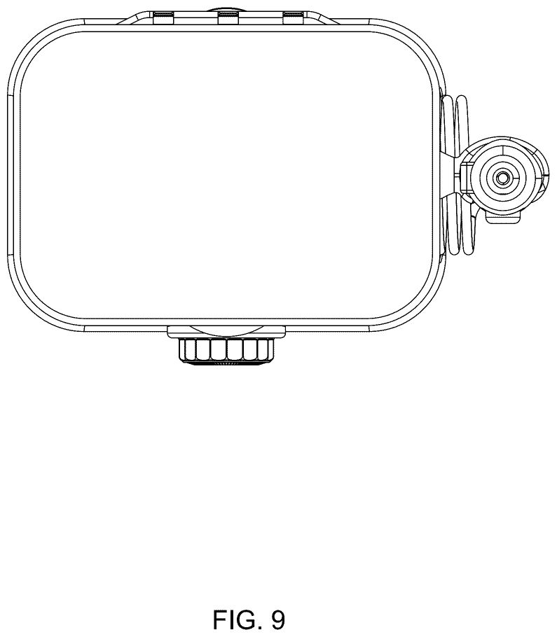

FIG. 10 is a bottom view of the dental hygiene system; the view showing the base; the view showing a plurality of feet of the base; the view showing a plurality of controls on the front side; the view showing part of the on/off switch on the rear side; the view showing the power cord storage and connection area; the view showing the flosser having an attachment tube; the view showing the flosser mounted or stored in the flosser holder on the side of the base.

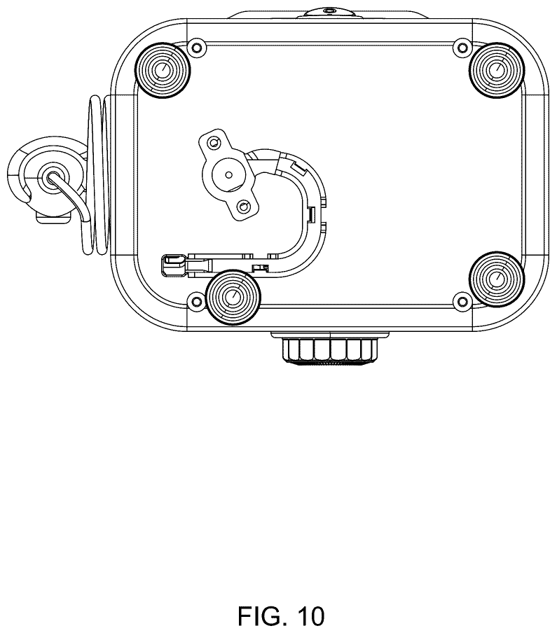

FIG. 11 is a side view of the dental hygiene system; the view showing a base having a plurality of feet and an on/off switch; the view showing a plurality of tanks; the view showing the plurality of tanks engaged with the base; the view showing a storage compartment; the view showing the storage compartment connected to the top of the plurality of tanks; the view showing a lid; the view showing the lid in the closed position on top of the storage compartment; the view showing a power source; the view showing storage area for a power cord and/or wall plug cord; the view showing the attachment location for a power cord.

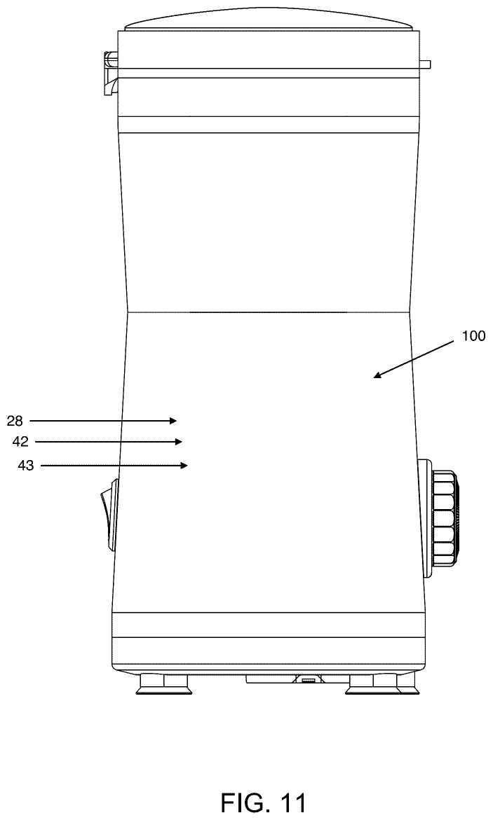

FIG. 12 is another side view of the dental hygiene system; the view showing a base having a plurality of feet and an on/off switch; the view showing a plurality of tanks; the view showing the plurality of tanks engaged with the base; the view showing a storage compartment; the view showing the storage compartment connected to the top of the plurality of tanks; the view showing a lid; the view showing the lid in the closed position on top of the storage compartment; the view showing a flosser; the view showing the flosser having an attachment tube; the view showing the flosser mounted or stored in the flosser holder on the side of the base.

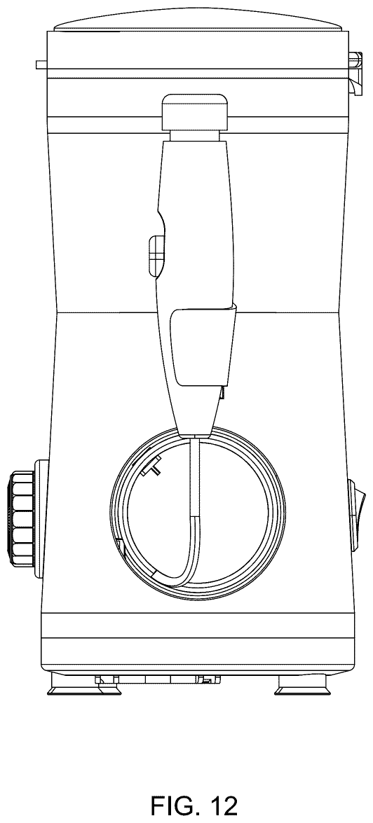

FIG. 13 is a top, perspective view of the dental hygiene system; the view showing the plurality of tanks disengaged and/or removed from the base; the view showing a base having a plurality of feet and a plurality of controls; the view showing a plurality of tanks; the view showing the plurality of tanks engaged with the base; the view showing a storage compartment; the view showing the storage compartment connected to the top of the plurality of tanks; the view showing a lid; the view showing the lid in the closed position on top of the storage compartment; the view showing a flosser; the view showing the flosser having an attachment tube; the view showing the flosser mounted or stored in the flosser holder on the side of the base.

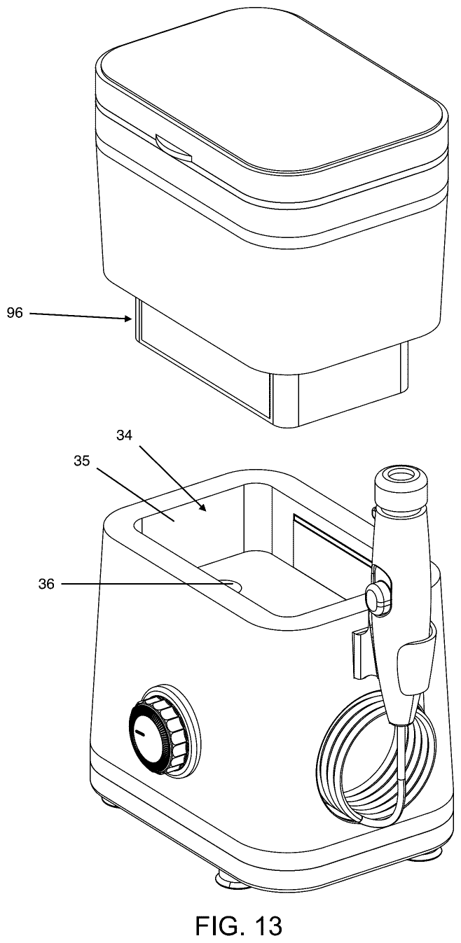

FIG. 14 is a bottom, perspective view of the dental hygiene system; the view showing the plurality of tanks disengaged and/or removed from the base; the view showing a base having a plurality of feet and a plurality of controls; the view showing a plurality of tanks; the view showing the plurality of tanks engaged with the base; the view showing a storage compartment; the view showing the storage compartment connected to the top of the plurality of tanks; the view showing a lid; the view showing the lid in the closed position on top of the storage compartment.

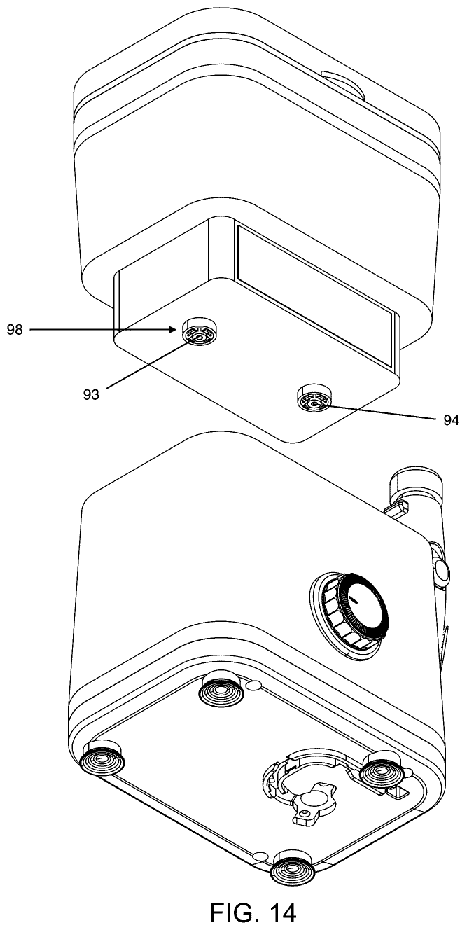

FIG. 15 is an exploded isometric view of the dental hygiene system; the view showing the plurality of tanks disengaged and/or removed from the base; the view showing the storage compartment removed from the top of the plurality of tanks where it serves as the lid; the view showing the lid removed from the top of the storage compartment; the view showing a base having a plurality of feet and a plurality of controls; the view showing a plurality of tanks; the view showing the plurality of tanks engaged with the base; the view showing a storage compartment; the view showing the storage compartment connected to the top of the plurality of tanks; the view showing a lid; the view showing the lid in the closed position on top of the storage compartment.

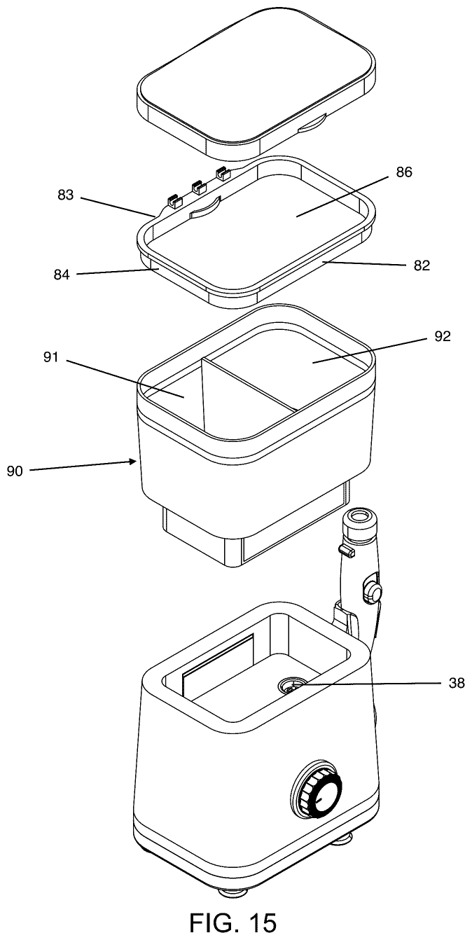

### DESCRIPTION

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium.

### System

With reference to the figures, a tooth hygiene system, a system dental hygiene, a dual tank flosser system, a hose and tank cleaning system, processes, and methods of use 10 are presented. a tooth hygiene system, a system dental hygiene, a dual tank flosser system, a hose and tank cleaning system, processes, and methods of use 10 (hereafter referred to as “dental hygiene system”, “tooth cleaning system”, “flossing system”, “dual tank system”, or simply “system”) is formed of any suitable size, shape and design.

In the arrangement shown, as one example, system 10 may comprise remote servers, databases, application servers, application databases, product databases, mobile applications, and/or computers; all of which in continuity or as separate acts fulfill the functions disclosed herein. System 10 also includes, in the embodiment(s) depicted, a user, a base 20, a dispenser or liquid flosser 50, a dispenser holder 60, a lid 70, a storage compartment 80, a plurality of tanks 90, and a computing platform, among other components, features, and functions.

### User (or Plurality Thereof)

In the arrangement shown, as one example, system 10 includes a user. User may be any user interacting with or utilizing the system 10. This may include viewing, controlling, analyzing, manipulating, and/or interacting with system 10. User is not limited to a single user but may be a plurality of users.

### Base

In the arrangement shown, as one example, system 10 includes a base 20 (also referred to as a “main body”). Base 20 is formed of any suitable size, shape and design and is configured to provide the support and house various functional components of system 10. In the arrangement shown, as one example, base 20 entends a length from a front 22 to a back 23 between opposing sides 24 and is box-like in shape with curved corners. The base 20 includes an exterior surface 26 and a hollow interior 28 along with a plurality of controls 30 (to be further described herein), an on/off switch 31, a plurality of feet 32, a power source 33, a tank receiver aperture 35 with a guide wall 35.

Within the tank receiver aperture 34, and located along the surface of the tank receiver aperture 34 are a first intake 36 and a second intake 38. Base 20 also includes a flosser hose attachment port 40. Base 20 may also include a heater or plurality of warmers 100 (to be further described herein), a cooler 42, and a mixer 43, among other components such as a computing platform (further described herein), pumps, tubes, wires, and the like.

### Plurality of Controls

In the arrangement shown, as one example, system 10 includes a plurality of controls 30 (also referred to as “first switch”, “second switch”, or simply “controls”). Controls 30 are formed of any suitable size, shape, and design, and are configured to allow a user to easily switch functionality of the system. In one control, the user may switch between tanks, such as switching from water to mouthwash and/or switch to a mix of two tanks, or more, and the like.

### Plurality of Warmers

In the arrangement shown, as one example, system 10 includes a plurality of warmers 100 (also referred to as “warming feature”, “warming plate”, or simply “warmers”). Warmers 100 are formed of any suitable size, shape, and design and are configured to warm the liquid in each of the plurality of tanks. These warmers may work individually or in concert, heating and/or warming one or more of the liquids of the tanks.

In the arrangement shown, as one example, warming plates are used which a user can activate to warm the liquid and/or warm the other holdings being stored in one or more of the tanks.

### Plurality of Dispensers

In the arrangement shown, as one example, system 10 includes a plurality of dispensers 98 (also referred to as “a first dispenser”, “a second dispenser”, or simply “dispensers”). The plurality of dispensers are each formed of any suitable size, shape, and design, and are configured to connect the tanks and/or transport the liquids of the tanks to be dispensed from the flosser. The first tank 91 includes a first dispenser 93 located at the bottom of the first tank 91. The second tank 92 includes a second dispenser 94 located at the bottom of the second tank. The first tank and second tank also include a bottom surface which is angled slightly from the outer walls to the dispenser (located in the center of the bottom) so that fluid can funnel into the respective dispenser.

In the arrangement shown, as one example, the figures depict a first dispenser and second dispenser. Additional dispensers are also included as may be for each additional tank such as a third tank, fourth tank, fifth tank, or the like.

### Flosser

In the arrangement shown, as one example, system 10 also includes a flosser 50. Flosser 50 is formed of any suitable size, shape, and design and is configured to eject or spray a stream of water and/or mouth wash. In the arrangement shown, as one example, the flosser 50 connects to the base 20, and in particular to the flosser hose attachment port 40 via an operational hose and/or flosser tube 48. The flosser tube 48 carrying, or providing conveyance of fluids from the base 20 to the flosser 50.

In the arrangement shown, as one example, flosser 50 extends a length from an input end 52 or bottom end to an output end 53 or top end. The flosser 50 includes an activation switch 58 and an ejection port 56 or dispenser port. In the arrangement shown, as one example, the flosser 50 may also include other controls such as intensity controls, temperature controls, on/off switches, and the like. Furthermore, the flosser may include a plurality of ejection ports such that a first ejection port is utilized for one fluid and a second ejection port is utilized for a second fluid. In this way, a second stream of hoses may link through the interior of the flosser back to the base and the respective plurality of tanks.

In the arrangement shown, as one example, a single flosser is shown mounted to the side of the base 20. In the arrangement shown, as one example, the flosser 50 is held or connected to the base by a flosser holder 60 or flosser mount 60 which a user can slide the flosser into and out of for ease of access, storage and operation. Additionally, the flosser mount 60 is secured to the base 20 via an attachment feature 61. However, multiple flossers are hereby contemplated for use. In another embodiment, a second flosser is mounted to the opposite side of the base as the first flosser. In this way, the second flosser can be utilized for a second fluid type and/or dedicated to a second fluid type and the like.

### Lid

In the arrangement shown, as one example, system 10 includes a lid 70. Lid 70 is formed of any suitable size, shape, and design and is configured to provide access to a storage compartment 80 (to be further described herein), located on the top of the plurality of tanks. The lid 70 extends a length from a front end 72 or opening end 72 to a rear end 73 or operably attached end 73. The lid extends from the front end to the rear end between opposing sides 74-and includes a top 75 and a bottom 77. The front end of the lid 70 includes a lip 76 which serves as a gripping or ease of opening feature. The rear end or operable end includes an attachment feature which provides for swinging the lid open. The lid may not have an attachment feature but instead be completely removed in alternative embodiments.

### Storage Compartment

In the arrangement shown, as one example, system 10 includes a storage compartment 80. Storage compartment is formed of any suitable size, shape and design and may vary in size, shape and design depending on the size desired. The storagement compartment 80 extends a length from a front end 82 to a rear end 83 between opposing sides 84. The storage compartment 80 includes a hollow interior 86 and may also include attachment features for securing the lid 70 operably to the storage compartment 80.

### Plurality of Tanks

In the arrangement shown, as one example, system 10 includes a plurality of tanks 90 (also referred to as “first tank”, “second tank”, or simply “tanks”). Plurality of tanks 90 are each formed of any suitable size, shape, and design, and are configured to store a plurality of liquids. In the arrangement shown, as one example, a first tank 91 stores water, a second tank 93 stores an antiseptic or mouth cleaning solution such as a mouthwash. In this way, a user can easily switch by the click of a button between what type of liquid is being dispensed from the flosser. Said another way, a user can switch from a water flosser to a mouthwash flosser. This improves upon dental hygiene health and ensures that the user will not have to empty a tank and change out a liquid in order to dispense the liquid.

The plurality of tanks also includes a base insert portion 96 or base insert guide 96 for easy alignment and stabilization in the base. This alignment and shape of the base insert 96 also ensures that the first dispenser 93 and the second dispenser 94 will align with the first intake 36 and the second intake 38 so as to form a tight seal, preventing leaks and providing for exact feeding and supply into the respective first hose and second hose which feed into the flosser or dispenser.

In the arrangement shown, as one example, two tanks are utilized. The two tanks comprising water and mouthwash respectively. However, any other number of tanks and different liquids being stored within the tanks are hereby contemplated for use. This may include a single tank which is divided into chambers. This may include three tanks, four tanks, five tanks, and various liquid types and/or non liquid types as may be desired to be dispensed such as other hygiene products, toothpaste and the like.

### Computing Platform

In the arrangement shown, as one example, system 10 includes a computing platform 300 (or “computer”, or “computer platform”). Computing platform 300 is formed of any suitable size, shape, and design and is configured to provide computing support, power, and computing processing for both onboard computing functionality as well as communication for off-board or server computing functionality. In this way, an onboard computing system, among other components and features on top of the platform.

In the arrangement shown, as one example, system 10 includes a computer 300. Computer 300 is formed of any suitable size, shape, and design and is configured to provide for the main off-board computing processing and implementation of computer handling of data from data gathering performed.

Computing platforms may include, but are not limited to, providing notifications of low tank levels, tracking historical data related to teeth cleaning and content used, including measurements, and the like. This may also include sending notifications to a phone with reminders to clean teeth and the like.

### Onboard Computing System

In one arrangement, as is shown, system 10 may also include an onboard computing system (or “onboard computing device”). Onboarding computing system is formed of any suitable size, shape, and design and configured to handle onboard computing operations, as are necessary for the operation of system 10. Onboarding computing device is connected with electronic network and/or database and/or server or cloud via communication means, bluetooth communication, bluetooth low energy chip (BLE onboard), and may include a processor, a memory, a microcontroller, a printed circuit board, a microprocessor, a receiver/transceiver, may include at least one antenna, and a global positioning system, among other components.

Computing device may be formed of and/or include any computing device capable of displaying and manipulating data in the manners described herein. Computing device may include for example a desktop computer, a laptop computer, a tablet, smart phone, or any other computing device or other interactive device.

Computing device may be a single consolidated component, or alternatively, computing device may be formed of a plurality of interconnected components that may be co-located or located at different geographic locations. Computing device may be cloud based or it may be hardware based, or cloud capable. In addition, the connected components of computing device, including processor, memory, software and interactive user display, may be co-located with a computing device or located at different geographic locations, independent control features, and the like. That is, computing device may be made of any form of a device or system that individually or collectively performs the computing operations of system 10.

Touchscreen: System 10 may also include a touchscreen for interacting with the system. This may include but is not limited to, adjusting the system 10 for dispensing type, tank, and/or ratio from multiple tanks. This may also include adjusting settings such as notifications and alerts, linking to a smart device, linking to wireless internet access, linking to bluetooth, and the like. The system may also send out notifications, such as push notifications when a tank is low and/or provide for ordering refills and the like.

Printed Circuit Board: In the arrangement shown, as one example, system 10 may include a printed circuit board (“PCB”). PCB is formed of any suitable size, shape and design and is configured to facilitate carrying and/or holding other components and/or parts necessary to carry out various computation and/or related functions of system 10. PCB, as one example, might be a surface mounted PCB or a through-hole PCB. PCB, as one example, is green and facilitates connecting the components and/or parts of system 10 by the use of traces and or vias. Traces are formed of any suitable size, shape and design and are configured as lines electrically connecting the components and/or parts of system 10. Vias are formed of any suitable size, shape and design and are configured as holes that connect layers of traces together. Generally, as in shown, traces and vias are soldered to connect the components and/or parts to the PCB.

In an alternative embodiment, system 10 may not include an onboard computer device, but instead houses only a receiver and/or transceiver for sending and/or receiving information which is both sensed and/or information which is sensed and/or captured by the image capturing devices of system 10. In this way, system 10 may be connected to a mobile computing device via a cellular connection, a direct connection, or other connections which provide a means of receiving and/or sending communications.

Microprocessor: Microprocessor is any computing device that receives and processes information and outputs commands according to instructions stored in memory. Memory is any form of information storage such as flash memory, RAM memory, a hard drive, or any other form of memory. Memory may be included as a part of or operably connected to a microprocessor. A receiver/transceiver is connected to a microprocessor. A receiver is used if one way communication is utilized, whereas a transceiver is used if two-way communication is utilized (hereinafter “transceiver”). Receiver/transceiver is connected with an antenna, such as a monopole antenna, a loop antenna, a fractal antenna, or any other form of an antenna. Antenna receives wireless signals from any other device, transmits these signals to receiver/transceiver which processes these signals and then transmits these processed signals to microprocessor which processes these signals according to instructions stored in memory. In one arrangement, system 10 re-transmits operating commands signals through receiver/transceiver so as to similarly control over-the-air communication. Communication is any form of wireless signals, or wired signals, through the air, such as a conventional remote signal, a cell phone, a wireless device, an internet connected device, a hard-wired device, or any other device capable of transmitting remote control signals.

Memory: In the arrangement shown, as one example, system 10 includes a memory. Memory may be formed of any suitable size, shape and design and is configured to facilitate selective storage and retrieval of data (including data) in association with computing devices, processors, software and interactive user display. Memory may be a single component, such as a single chip or drive or other memory device, or alternatively memory may be formed of a plurality of memory or storage components that are connected to one another that may be co-located or located at different geographic locations.

In addition to the above identified features, options, controls, and components, system 10 may also include other features and functionalities, among other options, controls, and components.

It will be appreciated by those skilled in the art that other various modifications could be made to the system, process, and method of use without parting from the spirit and scope of this disclosure. All such modifications and changes fall within the scope of the claims and are intended to be covered thereby.

1. A dental hygiene system, comprising:
a base;
the base extending a length from a front to a back between opposing sides;
the base having an exterior surface and a hollow interior;
the base having a plurality of controls;
the base having an on/off switch;
the base having a power supply;
the base having a first intake;
the base having a second intake;
the base having a flosser hose attachment port;
a flosser hose;
a flosser;
the flosser extending a length from an input end to an output end;
the flosser having a plurality of ejection ports;
the plurality of storage tanks housing having a first tank and a second tank;
the plurality of storage tanks housing having a base insert;
wherein activating the activation switch causes fluid to be ejected from the flosser.

2. The system of claim 1, further comprising:
wherein the activation switch is a slider switch.

3. The system of claim 1, further comprising:
wherein the activation switch is a button.

4. The system of claim 1, further comprising:
wherein the first tank stores water.

5. The system of claim 1, further comprising:
wherein the second tank stores mouthwash.

6. The system of claim 1, further comprising:
where the fluid is water.

7. The system of claim 1, further comprising:
wherein the fluid is mouthwash.

8. The system of claim 1, further comprising:
wherein the fluid is a mixture of water and mouthwash.

9. The system of claim 1, further comprising:
a heater;
wherein the heater is configured to warm the fluid prior to ejection; wherein warming the fluid is completed by electrical resistance in close proximity to the fluid.

10. The system of claim 1, further comprising:
a cooler;
wherein the cooler is configured to cool the fluid prior to ejection.

11. The system of claim 1, further comprising:
a computing platform;
a wireless internet connection;
a bluetooth connection;
wherein the hygiene system can connect to a smart device.

12. The system of claim 1, further comprising:
a pressure regulating control;
wherein the pressure rate at which the fluid is being ejected can be adjusted.

13. The system of claim 1, further comprising:
wherein the power source is a wall plug.

14. The system of claim 1, further comprising:
wherein the power source is a plurality of rechargeable batteries.

15. The system of claim 1, further comprising:
wherein the computing platform tracks historical usage and provides information related to usage such as notifications to encourage additional usage or less usage of the flosser.

16. The system of claim 1, further comprising:
a lid;
the lid extending a length from a front end to a rear end between opposing sides and having a top and a bottom;
the lid having a lip;
the lid having a plurality of attachment feature;
a storage compartment;
the storage compartment extending a length from a front end to a rear end between opposing sides;
the storage compartment having a hollow interior;
the storage compartment having a plurality of attachment features for removably connecting the lid;
the lid having a plurality of alignment features for removably connecting to a plurality of storage tanks;
wherein the storage compartment is a removable lid for the plurality of tanks.

17. The system of claim 1, further comprising:
a third tank.

18. The system of claim 1, further comprising:
a flosser tube;
wherein the flosser tube connects the flosser intake to the base.

19. A dual tank dental hygiene system
a base;
the base extending a length from a front to a back between opposing sides;
the base having an exterior surface and a hollow interior;
the base having a plurality of controls;
the base having an on/off switch;
the base having a power supply;
the base having a first intake;
the base having a second intake;
the base having a plurality of warmers;
a flosser;
the flosser extending a length from an input end to an output end;
the flosser having a plurality of ejection ports;
a lid;
the lid extending a length from a front end to a rear end between opposing sides and having a top and a bottom;
the lid having a plurality of attachment feature;
the lid having a plurality of alignment features for removably connecting to a plurality of storage tanks;
wherein the storage compartment is a removable lid for the plurality of tanks;
the plurality of storage tanks having a first tank and a second tank;
wherein the controls provide for switching a supply of the fluid from the first tank to the second tank;
wherein the controls provide for mixing the supply of the fluid from the first tank and the second tank;
wherein activating the activation switch causes fluid to be ejected from the flosser.

20. A dental hygiene tool comprising:
a base;
the base extending a length from a front to a back between opposing sides;
the base having an exterior surface and a hollow interior;
the base having a plurality of controls;
the base having an on/off switch;
the base having a plurality of feet;
the base having a power supply;
the base having a tank receiver aperture;
the base having a guide wall;
the base having a first intake;
the base having a second intake;
the base having a flosser hose attachment port;
the base having a plurality of warmers;
a flosser tube;
a flosser;
the flosser extending a length from an input end to an output end;
the flosser having a plurality of ejection ports;
the flosser having an activation switch;
a flosser holder;
the flosser holder having an attachment feature;
a lid;
the lid extending a length from a front end to a rear end between opposing sides and having a top and a bottom;
the lid having a lip;
the lid having a plurality of attachment feature;
a storage compartment;
the storage compartment extending a length from a front end to a rear end between opposing sides;
the storage compartment having a hollow interior;
the storage compartment having a plurality of attachment features for removably connecting the lid;
the lid having a plurality of alignment features for removably connecting to a plurality of storage tanks;
wherein the storage compartment is a removable lid for the plurality of tanks;
the plurality of storage tanks having a first tank and a second tank;
the first tank having a first dispenser;
the second tank having a second dispenser;
the plurality of tanks having a base insert;
wherein the flosser ejects a fluid for the purpose of tooth cleaning;
wherein the controls provide for switching a supply of the fluid from the first tank to the second tank;
wherein the controls provide for mixing the supply of the fluid from the first tank and the second tank;
wherein activating the activation switch causes fluid to be ejected from the flosser;
wherein the plurality of tanks are integrated into the flosser such that the flosser can be used conveniently without hose attachments.
